(19) United States
(12) Patent Application Publication
(10) Pub. No.: US 2022/0342771 A1
(43) Pub. Date: Oct. 27, 2022

(54) METHOD AND SYSTEM FOR GENERATING BACKUPS WITH HISTORICAL METADATA

(71) Applicant: EMC IP Holding Company LLC, Hopkinton, MA (US)

(72) Inventors: Manish Sharma, Bangalore (IN); Aaditya Rakesh Bansal, Bagalore (IN); Shelesh Chopra, Bangalore (IN); Sunil Yadav, Bangalore (IN)

(21) Appl. No.: 17/238,664

(22) Filed: Apr. 23, 2021

(51) Int. Cl. G06F 11/14

(52) U.S. Cl. CPC G06F 11/1464; G06F 11/1469; G06F 11/1453; G06F 11/1435

(57) ABSTRACT

Techniques described herein relate to a method for generating backups of assets. The method may include identifying, by a backup agent, a backup generation event associated with an asset; in response to identifying the backup generation event: obtaining change information associated with the asset, and the change information includes at least one change list; generating an asset backup using the at least one change list, in which the asset backup includes asset backup data, asset backup metadata, and historical metadata; and storing the asset backup in a backup storage.

### BACKGROUND

Computing devices may provide services. To provide the services, the computing devices may include hardware components and software components. Data may be generated by the computing devices during the performance of the services. Operations may be performed on the data. The data may be important to users. Operations may be performed on the data. The operations performed on the data and the point-in-time in which the operations were performed on the data may be important to users. To protect the data, backups of the data may be generated and stored in storage devices.

### SUMMARY

In general, certain embodiments described herein relate to a method for generating backups of assets. The method may include identifying, by a backup agent, a backup generation event associated with an asset; in response to identifying the backup generation event: obtaining change information associated with the asset, and the change information includes at least one change list; generating an asset backup using the at least one change list, in which the asset backup includes asset backup data, asset backup metadata, and historical metadata; and storing the asset backup in a backup storage.

In general, certain embodiments described herein relate to a system for generating backups of assets. The system may include a backup storage that includes persistent storage and a backup agent that include a processor and memory, and configured to identify a backup generation event associated with an asset; in response to identifying the backup generation event: obtain change information associated with the asset, and the change information includes at least one change list; generate an asset backup using the at least one change list, in which the asset backup includes asset backup data, asset backup metadata, and historical metadata; and store the asset backup in a backup storage.

In general, certain embodiments described herein relate to a non-transitory computer readable medium that includes computer readable program code, which when executed by a computer processor enables the computer processor to perform a method for generating backups of assets. The method may identifying, by a backup agent, a backup generation event associated with an asset; in response to identifying the backup generation event: obtaining change information associated with the asset, and the change information includes at least one change list; generating an asset backup using the at least one change list, in which the asset backup includes asset backup data, asset backup metadata, and historical metadata; and storing the asset backup in a backup storage.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1A shows a diagram of a system in accordance with one or more embodiments of the invention.

FIG. 1B shows a diagram of a production host in accordance with one or more embodiments of the invention.

FIG. 1C shows a diagram of a backup storage in accordance with one or more embodiments of the invention.

FIG. 2 shows a diagram of a file system metadata repository in accordance with one or more embodiments of the invention.

FIG. 3A shows a flowchart of a method of generating an asset backup in accordance with one or more embodiments of the invention.

FIG. 3B shows a flowchart of a method of generating an asset backup using a single change list in accordance with one or more embodiments of the invention.

FIG. 3C shows a flowchart of a method of generating an asset backup using a multiple change lists in accordance with one or more embodiments of the invention.

FIG. 4A shows a diagram of a first example in accordance with one or more embodiments of the invention.

FIG. 4B shows a diagram of a second example in accordance with one or more embodiments of the invention.

FIG. 5 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure and the number of elements of the second data structure may be the same or different.

In general, embodiments of the invention relate to a system and method for generating backups of application assets that include historical metadata. The asset backups may be generated using change information, the change information may include one or more change lists that specify operations performed on the assets since the generation of previously generated asset backups associated with the assets. Further, embodiments of the invention enable multiple change lists to be included in the change information. In such embodiments, a backup agent may be able to generate asset backup data associated with each list independently without waiting for and/or relying on the other change lists.

The historical metadata and asset backup metadata in such scenarios may be associated with each portion of the asset backup data generated using each change list and may include the storage locations of the aforementioned portions of the asset backup data. Thus, the backup agent may efficiently generate asset backups using one or more change lists. Furthermore, the historical metadata may be used to generate one or more point in time restorations using a single asset backup, and may be used by users of the system to obtain a complete history of assets and elements associated with the assets. As a result, asset backups that include historical metadata may be more useful to users of the system than traditional backups of application assets.

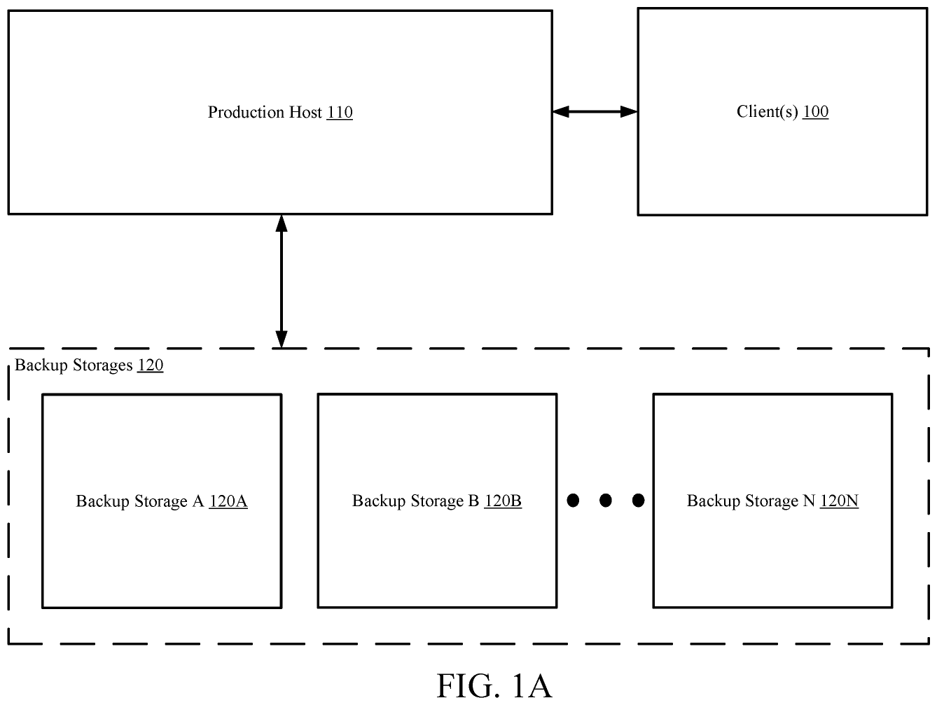

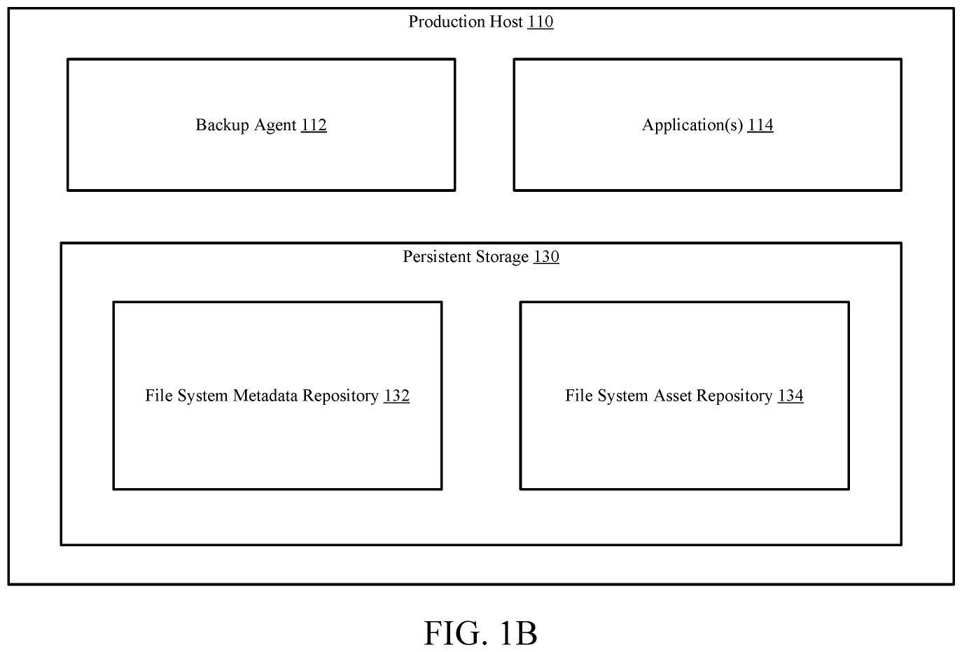

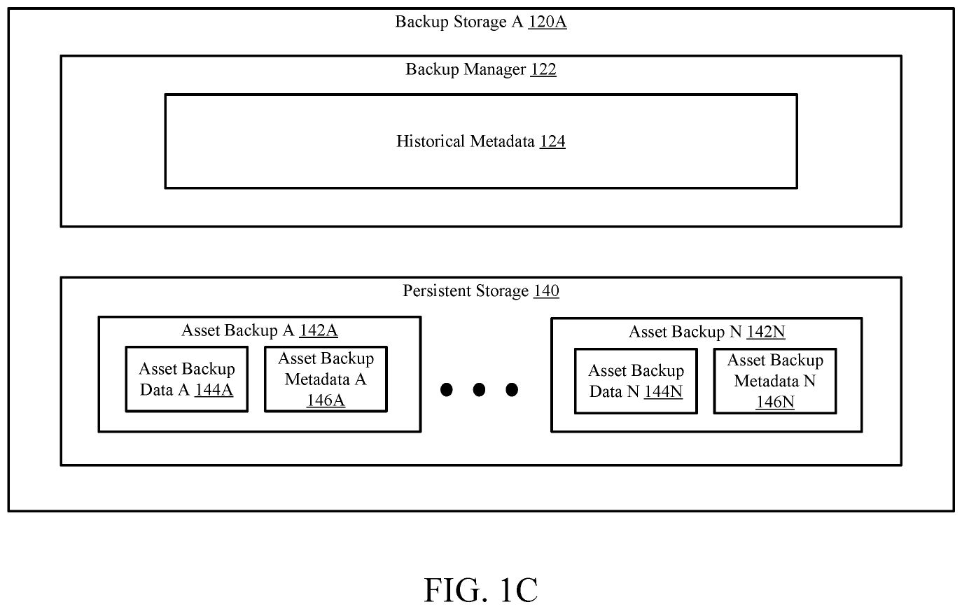

FIG. 1A shows a diagram of a system in accordance with one or more embodiments of the invention. The system may include client(s) (100), a production host (110), and backup storages (120). The system may include additional, fewer, and/or different components without departing from the invention. Each component may be operably connected to any of the other components via any combination of wired and/or wireless connections. Each of the aforementioned components is discussed below.

In one or more embodiments of the invention, the client(s) (100) utilize computer implemented services provided by the production host (110). Specifically, the client(s) (100) may utilize applications (discussed below) hosted by the production host to obtain, modify, and/or store data. The data may be generated from applications hosted in the production host (110).

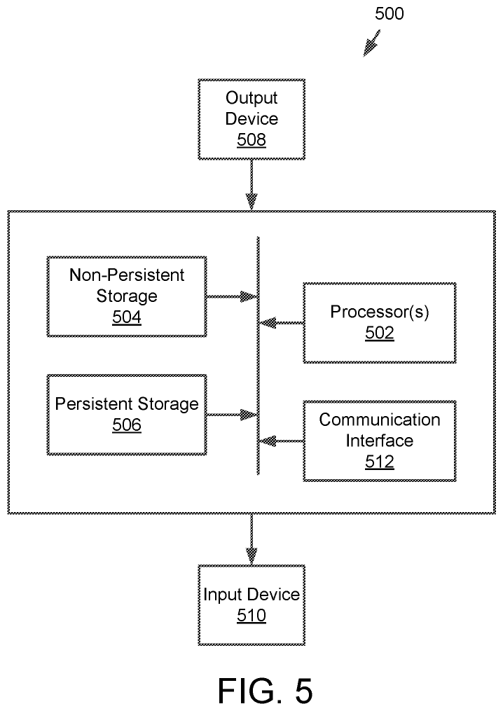

In one or more embodiments of the invention, a client(s) (100) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client(s) (100) described throughout this application.

In one or more embodiments of the invention, the client(s) (100) are implemented as a logical device. The logical device may utilize the computing resources of any number of computing devices and thereby provide the functionality of the client(s) (100) described throughout this application.

In one or more embodiments of the invention, the production host (110) provides computer implemented services to the client(s) (100). The computer implemented services may include database services, instant messaging services, electronic communication services, and any other type of computer implemented services without departing from the invention. The production host (110) may obtain backup storage services from the backup storages (120). The backup storage services may include storing backups of data generated by the client(s) and/or the production host (110) during the performance of the aforementioned computer implemented services. The backup storage services may further include obtaining backups to restoration of lost and/or corrupt data, and obtaining historical metadata (discussed below) to provide the client(s) a historical view of the data, perform point-in-time restorations of the data, and/or other and/or additional purposes without departing from the invention. The production host (110) may obtain and/or provide other and/or additional services without departing from the invention. For additional information regarding the production host (110), refer to FIG. 1B.

In one or more embodiments of the invention, the production host (110) is implemented as a computing device (see e.g., FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production host (110) described throughout this application. For additional information regarding the production host (110), refer to FIG. 1B.

In one or more embodiments of the invention, the production host (110) is implemented as a logical device. The logical device may utilize the computing resources of any number of computing devices and thereby provide the functionality of the production host (110) described throughout this application. For additional information regarding the production host (110), refer to FIG. 1B.

In one or more embodiments of the invention, the backup storages (120) includes the functionality to provide backup storage services to the production host as discussed above. The backup storage services may include (i) obtaining backups of data generated through the performance of computer implemented services, (ii) storing data and metadata, including historical metadata, associated with the backups in persistent storage of the backup storages (120), and (iii) providing backup data and/or historical metadata to the production host (110) for restoration purposes and/or other and/or additional purposes without departing from the invention. The backup storage services may include other and/or additional services without departing from the invention. The backup storages (120) may include any number of backup storages without departing from the invention. The backup storages (120) may include backup storage A (120A), backup storage B (120B), and backup storage N (120N). For additional information regarding the backup storages (120) refer to FIG. 1C.

In one or more embodiments of the invention, the backup storages (120) are implemented as a computing devices (see e.g., FIG. 5). A computing device of the computing devices may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device cause the computing device to perform the functionality of a backup storage (e.g., backup storage A (120A)) of the backup storages (120) described throughout this application.

In one or more embodiments of the invention, the backup storages (120) are implemented as logical devices. The logical devices may utilize the computing resources of any number of computing devices and thereby provide the functionality of the backup storages (120) described throughout this application.

FIG. 1B shows a diagram of a production host in accordance with one or more embodiments of the invention. The production host (110) may be an embodiment of the production host (110, FIG. 1A) discussed above. As discussed above, the production host may provide computer implemented services to the client(s) (100) and obtain backup storage services from the backup storages (120). To provide and obtain the aforementioned computer implemented services and the backup storage services, the production host may include a backup agent (112), application(s) (114), and persistent storage (130). The production host may include other and/or additional components without departing from the invention. Each of the aforementioned components is discussed below.

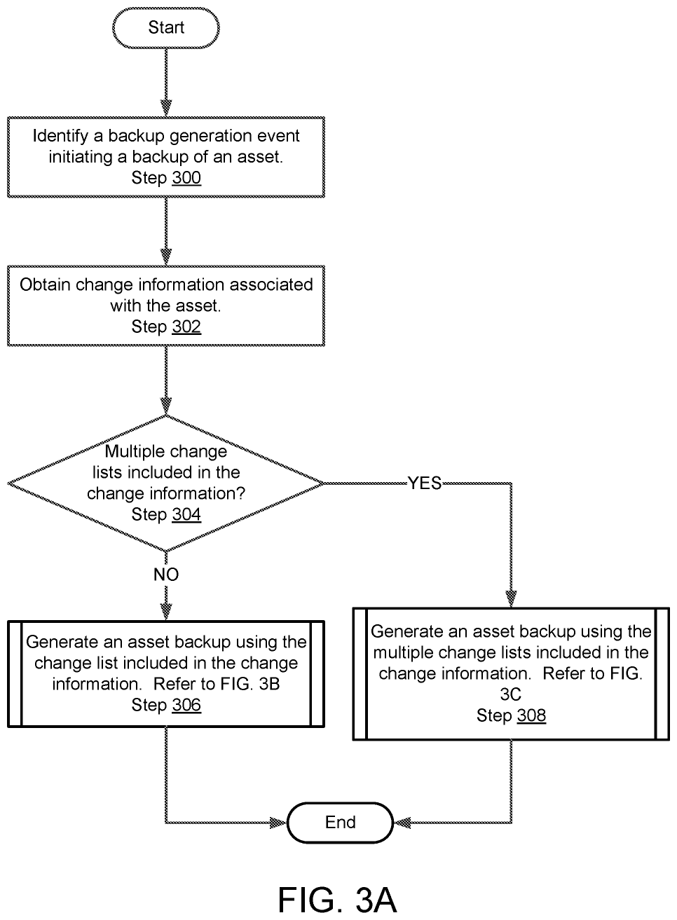

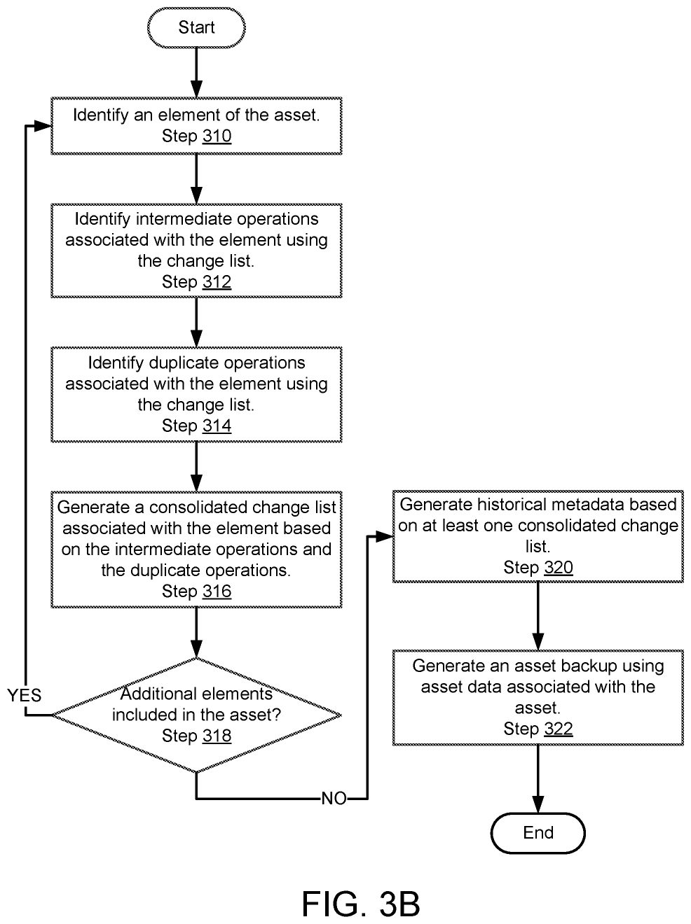

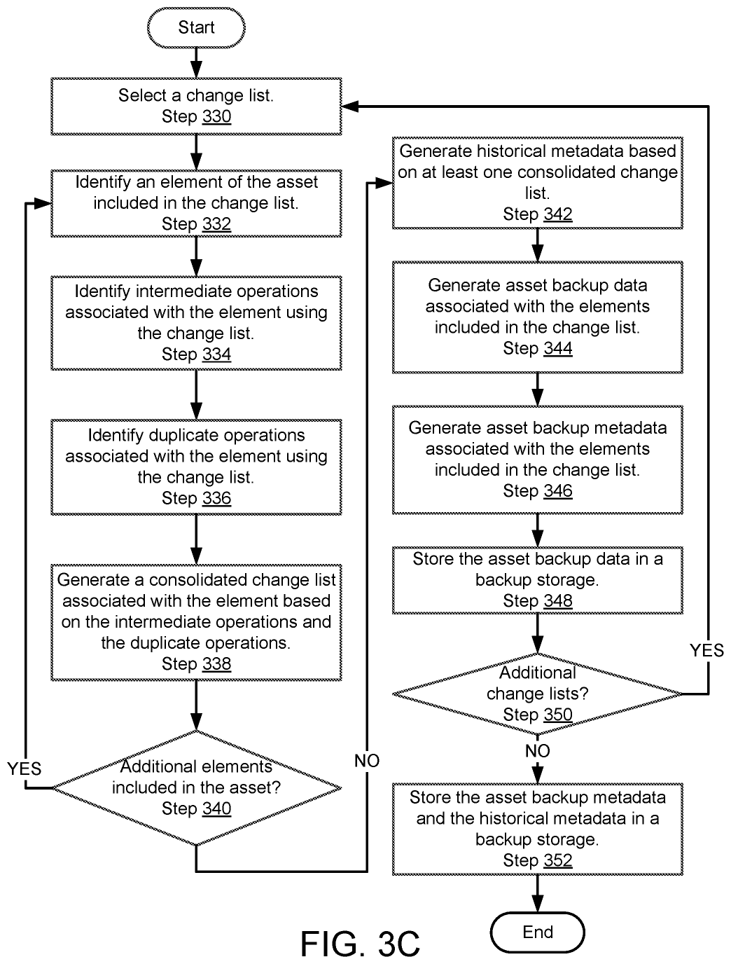

In one or more embodiments of the invention, the backup agent (112) includes the functionality to generate asset backups of data associated with the application(s) (114). The backups may include asset data of application assets included in a file system asset repository (134) (discussed below). The backup agent (112) may further include the functionality to generate historical metadata during the generation of the asset backups. The backup agent (112) may provide the asset backups and the historical metadata to the backup storages (120), where the asset backups and the historical metadata may be stored in persistent storage of the backup storages (120). To generate asset backups and historical metadata, the backup agent may maintain a file system metadata repository (132) (discussed below). In one or more embodiments of the invention, the backup agent (112) may further include functionality for tracking changes to assets of the file system and to generate and/or obtain change information associated with the assets. The backup agent (112) may generate asset backups and historical metadata via the methods illustrated in FIGS. 3A-3C. The backup agent may include other and/or additional functionality without departing from the invention.

In one or more embodiments of the invention, a file system is an organizational data structure that tracks how application data is stored and retrieved in a system (e.g., in persistent storage (130) of the production host (110), i.e., the file system repository (134)). The file system may specify references to assets of applications and any asset data associated with each asset. An asset may be an individual data object in the file system. An asset may be, for example, a folder associated with the application(s) (114). Each asset may include any number of elements. The elements may be, for example, subfolders and/or files associated with the application(s) (114). The asset backup may include a copy of the asset data for one or more specified applications or application assets that may be associated with a point in time. The copies of asset data may be used to generate the asset backups.

In one or more embodiments of the invention, the backup agent (112) may generate and provide to the backup storage (120) the asset backups and the historical metadata based on backup policies implemented by the backup agent (112). The backup policies may specify a schedule in which the applications (e.g., 114) or assets associated with the applications are to be backed up. The backup agent (112) may be triggered to generate an asset backup and historical metadata and provide the an asset backup and historical metadata to the backup storages (120) in response to a backup policy. Alternatively, asset backup and historical metadata may be generated by the backup agent (112) and provided to the backup storages (120) in response to a backup request triggered by the client(s) (100). The backup request may specify the applications(s) (114) and/or assets associated with the applications (114) to be backed up.

In one or more embodiments of the invention, the backup agent (112) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup agent (112) described throughout this application.

In one or more embodiments of the invention, the backup agent (112) is implemented as computer instructions, e.g., computer code, stored on a persistent storage that when executed by a processor of the production host (110) causes the production host (110) to provide the functionality of the backup agent (112) described throughout this application.

In one or more embodiments of the invention, the production host (110) hosts one or more applications (114). In one or more embodiments of the invention, the application(s) (114) perform computer implemented services for clients (e.g., 100). Performing the computer implemented services may include performing operations on asset data that is stored in the production host (110). The operations may include creating elements of assets, moving elements of assets, modifying elements of assets, deleting elements of assets, and other and/or additional operations on asset data without departing from the invention. The application(s) (114) and/or users of the client(s) (100, FIG. 1A) may include functionality for performing the aforementioned operations on the asset data in the production host (110). The application(s) (114) may be, for example, instances of databases, email servers, and/or other applications. The production host (110) may host other types of applications without departing from the invention.

In one or more of embodiments of the invention, the application(s) (114) is implemented as computer instructions, e.g., computer code, stored on a persistent storage (e.g., 130) that when executed by a processor(s) of the production host (110) cause the production host (110) to provide the functionality of the application(s) (114) described throughout this application.

In one or more embodiments of the invention, the persistent storage (130) stores data. The persistent storage (130) may include a file system metadata repository (132) and a file system asset repository (134). The file system metadata repository (132) and the file system asset repository (134) may be stored in persistent storage of remote storage devices of entities not shown in the system of FIG. 1A without departing from the invention. The persistent storage (130) may store other and/or additional data without departing from the invention. Each of the aforementioned types of data stored in the persistent storage (130) is discussed below.

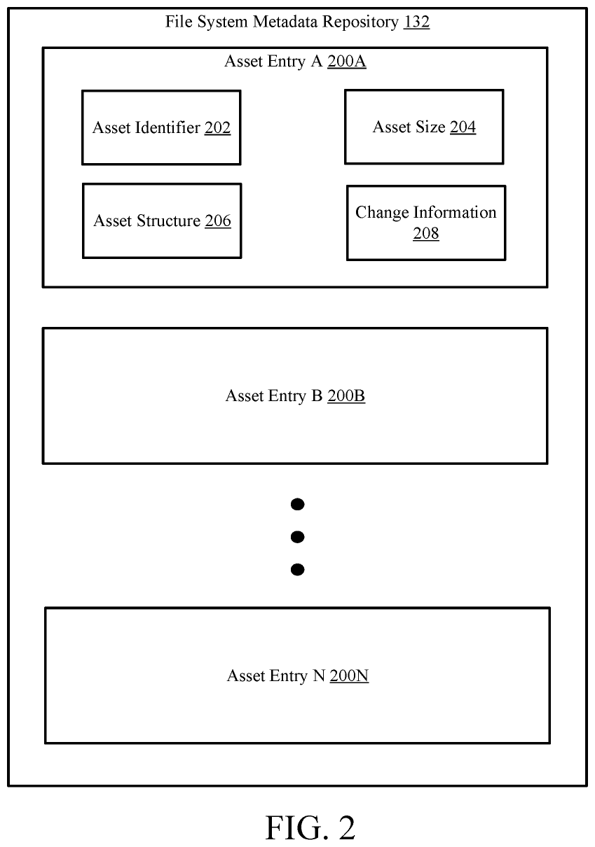

The file system metadata repository (132) may be one or more data structures that include information regarding application assets stored in the file system asset repository. The information included in the file system metadata repository (132) may be used by the backup agent to generate asset backups and historical metadata. The file system metadata repository (132) may include other and/or additional information without departing from the invention. For additional information regarding the file system metadata repository (132), refer to FIG. 2.

The file system asset repository (134) may include one or more data structures that may be used to generate asset backups. The file system asset repository (134) may include asset data generated by users of the application(s) (114) as discussed above. The asset data may be any type of data such as database data and email data generated by users of the application(s) (114) without departing from the invention. Each application of the application(s) (114) may include any number of assets, each asset may include any quantity of asset data, and furthermore, each asset may include any number of elements without departing from the invention. Users (e.g., clients (100)) may use the asset data of the file system asset repository (134) when obtaining computer implemented services from the production host (110, FIG. 1A). Additionally, the asset data of the file system asset repository (134) may be obtained by the backup agent (112) to generate asset backups. The asset data of the file system asset repository (134) may be used by other and/or additional entities for other and/or additional purposes without departing from the invention.

The persistent storage (130) may be implemented using physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the persistent storage (130) may utilize portions of any combination of hard disk drives, solid state disk drives, tape drives, and/or any other physical storage medium of any number of computing devices.

FIG. 1C shows a diagram of a backup storage in accordance with one or more embodiments of the invention. Backup storage A (120A) may be an embodiment of a backup storage of the backup storages (e.g., 120, FIG. 1A) discussed above. As discussed above, backup storage A (120A) may provide backup storage services to the production host (110, FIG. 1A). To provide the aforementioned backup storage services, backup storage A (120A) may include a backup manager (122) and persistent storage (140). Backup storage A (120A) may include other and/or additional components without departing from the invention. Each of the aforementioned components is discussed below.

In one or more embodiments of the invention, the backup manager (122) includes functionality to obtain asset backups (e.g., 142A, 142N) and historical metadata (124) from the production host (110, FIG. 1A), and store the asset backups (e.g., 142A, 142N) and historical metadata (124) in persistent storage (140). The backup manager (122) may also include the functionality to provide asset backups (e.g., 142A, 142N) and historical metadata (124) to the production host (110, FIG. 1A) for restoration purposes, asset history monitoring purposes, and/or other and/or additional purposes without departing from the invention. The backup manager (122) may further include the functionality to maintain the historical metadata (124) based on the generation of asset backups. The backup manager (122) may include other and/or additional functionalities without departing from the invention.

The historical metadata (124) may be one or more data structures that include historical information associated with each asset of the application(s) (114, FIG. 1B). The historical information may specify a complete chronological history of application assets. For each asset, the historical information may include and/or specify the operations performed on the asset, operation identifiers (e.g., an operation numbers that may be used to specify the operations), descriptions of the operations, timestamps associated with the performance of the operations, asset identifiers, client identifiers, user identifiers associated with the users that performed the operations, and other and/or additional information associated with the history of the assets without departing from the invention. The historical metadata (124) may be stored across the storage devices of the persistent storage (140) and/or of the backup manager (122). The historical metadata (124) may be used by the backup agent (112, FIG. 1B) to perform multiple point in time restorations using a single asset backup. The historical metadata (124) may be used by users of the client(s) (100, FIG. 1A) to obtain a historical view of an asset. The historical metadata (124) may be generated by the backup agent (112, FIG. 1B) during the generation of asset backups. The historical metadata (124) associated with assets may be updated by the backup manager (122) when the backup manager (122) obtains additional historical metadata (124) associated with the asset due to the generation of a new asset backup associated with the asset.

In one or more embodiments of the invention, the backup manager (122) is a physical device. The physical device may include circuitry. The physical device may be, for example, a field-programmable gate array, application specific integrated circuit, programmable processor, microcontroller, digital signal processor, or other hardware processor. The physical device may be adapted to provide the functionality of the backup manager (122) described throughout this application.

In one or more embodiments of the invention, the backup manager (122) is implemented as computer instructions, e.g., computer code, stored on a persistent storage (140) that when executed by a processor of backup storage A (120A) causes backup storage A (120A) to provide the functionality of the backup manager (122) described throughout this application.

In one or more embodiments of the invention, the persistent storage (140) stores data. The data stored in persistent storage (140) may include asset backups of asset data associated with applications of the production host (110, FIG. 1B). The persistent storage (140) may store any quantity of asset backups without departing from the invention. The persistent storage (140) may store asset backup A (142A) and asset backup N (142N). The persistent storage (140) may store other and/or additional data without departing from the invention.

The asset backups, e.g., asset backup A (142A) and asset backup N (142N), may be one or more data structures that include asset backup data (e.g., asset backup data A (144A) and asset backup data N (142N)) and asset backup metadata (e.g., asset backup metadata A (146A) and asset backup metadata N (146N)). The asset backup data (e.g., 144A, 144N) may include copies of asset data obtained from the file system asset repository (134, FIG. 1B) and used by the backup agent (112, FIG. 1B) to generate the asset backups (e.g., 142A, 142N). The asset backup data (e.g., 144A, 144N) may include copies of asset data associated with any quantity of assets and any quantity of asset elements without departing from the invention. Asset backups may be generated in parallel and, therefore, asset backup data (e.g., 144A, 144N) may be stored in the persistent storage (140) at different times and in different locations (i.e., different portions of different storage devices of the persistent storage (140)). The asset backup metadata (e.g., 146A, 146N) may include information associated the corresponding asset backup data (e.g., 144A, 144N). The information may include asset identifiers, asset structures, asset sizes, and storage locations associated with the corresponding asset data (e.g., 144A, 144N) of assets included in the asset backups (e.g., 142A, 142N). The asset backups (e.g., 142A, 142N) may include other and/or additional data and/or information without departing from the invention.

The persistent storage (140) may be implemented using physical storage devices and/or logical storage devices. The physical storage devices may include any combination of hard disk drives, solid state disk drives, tape drives, and/or any other physical storage mediums for the storage of data.

The logical storage devices (e.g., virtualized storage) may utilize any quantity of hardware storage resources of any number of computing devices for storing data. For example, the persistent storage (140) may utilize portions of any combination of hard disk drives, solid state disk drives, tape drives, and/or any other physical storage medium of any number of computing devices.

FIG. 2 shows a diagram of a file system metadata repository in accordance with one or more embodiments of the invention. The file system metadata repository may be an embodiment of the file system metadata repository (132, FIG. 1B) discussed above. As discussed above, the file system metadata repository (132) may include information associated with assets included in the file system asset repository used by the backup agent (112, FIG. 1B) to generate asset backups (e.g., 142A, 142N, FIG. 1C) and historical metadata (124, FIG. 1C). The file system metadata repository (132) may be generated and maintained by the backup agent (112, FIG. 1B). The information included the file system metadata repository may be generated by application(s) (114, FIG. 1B) and/or user of client(s) (100, FIG. 1A) during the performance of computer implemented services, and obtained by the backup agent (112, FIG. 1B) and included in the file system metadata repository (132) periodically and/or during the generation of asset backups and historical metadata. The file system metadata repository (132) may include any quantity of asset entries. The file system metadata repository (132) may include asset entry A (200A), asset entry B (200B), and asset entry N (200N).

In one or more embodiments of the invention, asset entry A (200A) includes an asset identifier (202), an asset size (204), an asset structure (206), and change information (208). An asset identifier (202) may be a unique global bit string associated with the asset associated with asset entry A (200A) that may be used by components of the system illustrated in FIG. 1A to specify the asset associated with asset entry A (200A) from other assets. The asset size (204) may specify the overall size of the asset and/or sizes of the elements included in the asset. The asset size (204) may include any representation of quantity of data (e.g., megabytes, kilobytes, etc.) without departing from the invention. The asset structure (206) may specify elements included in the asset. The asset structure (206) may include element identifiers, or unique, global bit strings associated with the elements that may be used to specify each element of the asset. Elements in the asset may be associated with a hierarchical structure, where one element may be a parent element of another (i.e., a subfolder may be a parent element of a file included in the subfolder), and the asset structure may specify the parent element associated with each element in the asset.

The change information (208) may include one or more change lists that specify operations performed on the asset and timestamps associated with the performance of the operations. The change information may include change list identifiers (e.g., a unique, global bit string associated with a change list) and corresponding asset identifiers. The change lists may further include operation identifiers (e.g., an operation numbers that may be used to specify the operations), descriptions of the operations, timestamps associated with the performance of the operations, asset identifiers, element identifiers, client identifiers, user identifiers associated with the users that performed the operations, and other and/or additional information associated with the operations performed on the asset without departing from the invention. Asset entry A (200A) may also include asset backup identifiers and corresponding timestamps (e.g., a date and time) (both not shown) associated with asset backups of the asset associated with asset entry A (200A). Asset entry A (200A) may include other and/or additional information associated with the asset associated with asset entry A (200A) without departing from the invention. Asset entry B (200B) and asset entry N (200N) may also include the aforementioned components without departing from the invention.

FIG. 3A shows a flowchart of a method of generating an asset backup in accordance with one or more embodiments of the invention. The method may be performed by, for example, a backup agent (112, FIG. 1B) of a production host (110, FIG. 1A). Other components of the system illustrated in FIG. 1A may perform all, or a portion of the method of FIG. 3A without departing from the invention.

While FIG. 3A is illustrated as a series of steps, any of the steps may be omitted, performed in a different order, additional steps may be included, and/or any or all of the steps may be performed in a parallel and/or partially overlapping manner without departing from the invention.

In step 300, a backup generation event initiating a backup of an asset is identified.

In one or more embodiments of the invention, the backup generation event is identified by the backup agent as point in time specified by a backup policy associated with the generation of an asset backup of an asset or obtaining a message from a client requesting the generation of an asset backup of the asset. In one embodiment, the backup agent may include a backup policy associated with the asset that specifies points in time to generate asset backups of the asset. The backup agent may monitor the backup policy and identify when a point in time specified by the backup policy occurs. The backup policy may include the asset identifier associated with the asset corresponding with the backup policy. The identification of the point in time specified by the backup policy may result in the identification of the backup generation event by the backup agent. In another embodiment of the invention, a user of a client may send a message to the backup agent. The message may include a request to generate an asset backup of the asset. The message may include an asset identifier associated with the asset. The backup agent may identify obtaining the aforementioned message as the backup generation event. The backup generation event initiating a backup of an asset may be identified via other and/or additional methods without departing from the invention.

In step 302, change information associated with the asset is obtained.

In one or more embodiments of the invention, the backup agent obtains the change information from the file system metadata repository and/or the applications of the production host and/or another entity that monitors the file system asset repository to track operations performed on the assets of the applications. The backup agent may use the asset identifier specified in the backup policy or message discussed above in step 300 to identify an asset entry of the file system metadata repository associated with the asset identifier to identify a timestamp after which change information associated with the asset is to be obtained. If a previous asset backup associated with the asset was generated, the backup agent may use the information included in the asset entry to obtain the change information associated with the asset to include the operations performed on the asset since the previous asset backup was generated. As discussed above, the change information may include one or more change lists. The change information may be obtained as a single change list or as multiple change lists obtained over a period of time without departing from the invention. The change information associated with the asset may be obtained via other and/or additional methods without departing from the invention.

In step 304, a determination is made as to whether the change information includes multiple change lists.

As discussed above, the change information may include one or more change lists. For example, the change information may include a change list associated with each element associated with the asset. The change information may specify the quantity of change lists included in the change information. For example, the change information may include a list of change list identifiers associated with each change list included in the change information. The backup information may check the change information to identify the number of change lists included in the change information. If the change information specifies that multiple change lists are included in the change information, then the backup agent may determine that there are multiple change lists included in the change information. If the change information specifies that only a single change list is included in the change information, then the backup agent may determine that there are not multiple change lists included in the change information. It may be determined whether multiple change lists are included in the change information via other and/or additional methods without departing from the invention.

If it is determined that the change information includes multiple change lists, then the method may proceed to step 308. If it is determined that the change information does not include multiple change lists (i.e., includes a single change list), then the method proceeds to step 306.

In step 306, an asset backup is generated using the single change list included in the change information.

In one or more embodiments of the invention, the backup agent generates an asset backup, including historical metadata associated with the asset backup, using the single change list, and stores the asset backup and the historical metadata in a backup storage of the backup storages. For additional information regarding the generation of an asset backup using a single change list included in the change information, refer to FIG. 3B.

The method may end following step 306.

In step 308, an asset backup is generated using the multiple change lists included in the change information.

In one or more embodiments of the invention, the backup agent generates an asset backup, including historical metadata associated with the asset backup, using the multiple change lists, and stores the asset backup and the historical metadata in a backup storage of the backup storages. For additional information regarding the generation of an asset backup using the multiple change lists included in the change information, refer to FIG. 3C.

The method may end following step 308.

FIG. 3B shows a flowchart of a method of generating an asset backup using a single change list in accordance with one or more embodiments of the invention. The method may be performed by, for example, a backup agent (112, FIG. 1B) of a production host (110, FIG. 1A). Other components of the system illustrated in FIG. 1A may perform all, or a portion of the method of FIG. 3B without departing from the invention.

While FIG. 3B is illustrated as a series of steps, any of the steps may be omitted, performed in a different order, additional steps may be included, and/or any or all of the steps may be performed in a parallel and/or partially overlapping manner without departing from the invention.

In step 310, an element of the asset is identified.

In one or more embodiments of the invention, the backup agent identifies an element included in the change list using the element identifiers included in the change list. As discussed above the change list may include element identifiers associated with each operation performed on the asset. The backup agent may identify an element identifier that was not previously identified during the generation of the asset backup. The backup agent may not begin identifying elements included in the change list until the entirety of the change list is obtained. An element of the asset may be identified via other and/or additional methods without departing from the invention.

In step 312, intermediate operations associated with the element are identified using the change list.

In one or more embodiments of the invention, the backup agent identifies intermediate backup operations associated with the element using the change list to determine whether the element is to be included in the asset backup. The intermediate operations may include a list of operations and information associated with the operations performed on the element after the point in time in which the previously generated backup associated with the asset was generated. The intermediate operations may include creating the element, moving the element, modifying the element, and deleting the element. The backup agent identifies all operations associated with creating the element and/or modifying the element as intermediate backup operations that indicate the element is to be included in the asset backup. In other words, the backup agent may determine to include the element in the asset backup if the intermediate operations indicate that the element is associated with new and/or modified asset data that is not included in a previous asset backup associated with the asset. The intermediate operations may also be associated with points in time in which the operations were performed. The intermediate backup operations associated with the element may be identified using the change list via other and/or additional methods without departing from the invention.

In step 314, duplicate operations associated with the element are identified using the change list.

In one or more embodiments of the invention, the backup agent identifies duplicate operations associated with the element included in the change list using the information associated with the operations included in the change list. The information included in the change list may specify the types of operations performed on the element and the points in time associated with the operation. The backup manager may identify multiple operations of the same type performed in a short period of time as duplicate operations. For example, a change list may specify that the asset may be modified 100 times over the course of the course of several minutes. The modifications may all include writes of data. The backup agent in this scenario may identify these operations in the change list as duplicate operations. Duplicate operations associated with the element may be identified using the change list via other and/or additional methods without departing from the invention.

In step 316, a consolidated change list associated with the element is generated based on the intermediate operations and the duplicate operations.

In one or more embodiments of the invention, the backup agent generates a consolidated list associated with the element based on the intermediate operations and the duplicate operations by deleting duplicate operations and merging the remaining intermediate operations to generate a single starting point and end point associated with the element. The duplicate operations may represented as a single operation that reflects the changes to the element through all operations and the duplicate operations may be deleted. Additionally, the intermediate operations may be ordered chronologically to identify the point in time in which the element was first created and/or modified and to identify the point in time in which the element was last modified, deleted, and/or moved. The consolidated change list associated with the element may be generated based on the intermediate operations and the duplicate operations via other and/or additional methods without departing from the invention.

In step 318, a determination is made as to whether any additional elements are included in the asset.

In one or more embodiments of the invention, the backup agent determines whether any additional elements are included in the change list using the element identifiers included in the change list. As discussed above the change list may include element identifiers associated with each operation performed on the asset. The backup agent may identify an element identifier that was not previously identified during the generation of the asset backup. If the backup agent identifies an element identifier that was not previously identified during the generation of the asset backup, then the backup agent may determine that an additional element is included in the change list. If the backup agent does not identify an element identifier that was not previously identified during the generation of the asset backup, then the backup agent may determine that no additional elements are included in the change list. The determination as to whether any additional elements are included in the asset may be made via other and/or additional methods without departing from the invention.

If it is determined that there is an additional element included in the asset, then the method may proceed to step 310. If it is determined that there are no additional elements included in the asset, then the method may proceed to step 320.

In step 320, historical metadata is generated based on the at least one consolidated change list.

In one or more embodiments of the invention, the backup agent generates historical metadata using the at least one consolidated change list. The backup agent may chronologically order the operations performed on each element in the at least one consolidated change list and may include the chronologically ordered operations of the elements of the asset in the historical metadata. The backup agent may also include information regarding each operation performed on the elements of the asset in the historical metadata. The historical metadata may be generated based on the at least one consolidated change list via other and/or additional methods without departing from the invention.

In step 322, an asset backup is generated using asset data associated with the asset.

In one or more embodiments of the invention, the backup agent generates an asset backup using asset data associated with the asset based on the at least one consolidated change list. The backup agent may obtain asset data associated with elements that are associated with intermediate operations that indicate the elements have been modified since the generation of a previously generated asset backup associated with the asset. The backup agent may further obtain asset metadata from the asset entry associated with the asset included in the file system metadata repository. The backup agent may include the obtained asset data in the asset backup as asset backup data, and may include the obtained asset metadata in the asset backup as asset backup metadata. The backup agent may include the an asset backup identifier associated with the asset backup in the asset backup metadata. The backup agent may also include the asset backup identifier associated with the previously generated asset backup associated with asset in the asset backup repository. The backup agent may store the asset backup in a backup storage of the backup storages and update or initiate the update of the asset backup metadata to include the storage location(s) of the asset backup. The asset backup may be generated using asset data associated with the asset via other and/or additional methods without departing from the invention.

The method may end following step 322.

FIG. 3C shows a flowchart of a method of generating an asset backup using a multiple change lists in accordance with one or more embodiments of the invention. The method may be performed by, for example, a backup agent (112, FIG. 1B) of a production host (110, FIG. 1A). Other components of the system illustrated in FIG. 1A may perform all, or a portion of the method of FIG. 3C without departing from the invention.

While FIG. 3C is illustrated as a series of steps, any of the steps may be omitted, performed in a different order, additional steps may be included, and/or any or all of the steps may be performed in a parallel and/or partially overlapping manner without departing from the invention.

In step 330, a change list is selected.

In one or more embodiments of the invention, the backup agent identifies an change list included in the change information using the change list identifiers included in the change information. As discussed above the change information may include change list identifiers associated with each change list included in the change information associated with the asset. The backup agent may identify an change list identifier that was not previously identified during the generation of the asset backup. The backup agent may select the identified change list. The backup agent may proceed with the generation of the asset backup as soon as a change list is obtained and selected. The backup agent may not be required to wait until all change lists are obtained. A change list may be selected via other and/or additional methods without departing from the invention.

In step 332, an element of the asset included in the change list is identified.

In one or more embodiments of the invention, the backup agent identifies an element included in the change list using the element identifiers included in the change list. As discussed above the change list may include element identifiers associated with each operation performed on the asset. The backup agent may identify an element identifier that was not previously identified during the generation of the asset backup. The backup agent may not begin identifying elements included in the change list until the entirety of the change list is obtained. An element of the asset may be identified via other and/or additional methods without departing from the invention.

In step 334, intermediate operations associated with the element are identified using the change list.

In one or more embodiments of the invention, the backup agent identifies intermediate backup operations associated with the element using the change list to determine whether the element is to be included in the asset backup. The intermediate operations may include a list of operations and information associated with the operations performed on the element after the point in time in which the previously generated backup associated with the asset was generated. The intermediate operations may include creating the element, moving the element, modifying the element, and deleting the element. The backup agent identifies all operations associated with creating the element and/or modifying the element as intermediate backup operations that indicate the element is to be included in the asset backup. In other words, the backup agent may determine to include the element in the asset backup if the intermediate operations indicate that the element is associated with new and/or modified asset data that is not included in a previous asset backup associated with the asset. The intermediate operations may also be associated with points in time in which the operations were performed. The intermediate backup operations associated with the element may be identified using the change list via other and/or additional methods without departing from the invention.

In step 336, duplicate operations associated with the element are identified using the change list.

In one or more embodiments of the invention, the backup agent identifies duplicate operations associated with the element included in the change list using the information associated with the operations included in the change list. The information included in the change list may specify the types of operations performed on the element and the points in time associated with the operation. The backup manager may identify multiple operations of the same type performed in a short period of time as duplicate operations. For example, a change list may specify that the asset may be modified 100 times over the course of the course of several minutes. The modifications may all include writes of data. The backup agent in this scenario may identify these operations in the change list as duplicate operations. Duplicate operations associated with the element may be identified using the change list via other and/or additional methods without departing from the invention.

In step 338, a consolidated change list associated with the element is generated based on the intermediate operations and the duplicate operations.

In one or more embodiments of the invention, the backup agent generates a consolidated list associated with the element based on the intermediate operations and the duplicate operations by deleting duplicate operations and merging the remaining intermediate operations to generate a single starting point and end point associated with the element. The duplicate operations may represented as a single operation that reflects the changes to the element through all operations and the duplicate operations may be deleted. Additionally, the intermediate operations may be ordered chronologically to identify the point in time in which the element was first created and/or modified and to identify the point in time in which the element was last modified, deleted, and/or moved. The consolidated change list associated with the element may be generated based on the intermediate operations and the duplicate operations via other and/or additional methods without departing from the invention.

In step 340, a determination is made as to whether additional elements are included in the asset.

In one or more embodiments of the invention, the backup agent determines whether any additional elements are included in the change list using the element identifiers included in the change list. As discussed above the change list may include element identifiers associated with each operation performed on the asset. The backup agent may identify an element identifier that was not previously identified during the generation of the asset backup. If the backup agent identifies an element identifier that was not previously identified during the generation of the asset backup, then the backup agent may determine that an additional element is included in the change list. If the backup agent does not identify an element identifier that was not previously identified during the generation of the asset backup, then the backup agent may determine that no additional elements are included in the change list. The determination as to whether any additional elements are included in the asset may be made via other and/or additional methods without departing from the invention.

If it is determined that there is an additional element included in the asset, then the method may proceed to step 332. If it is determined that there are no additional elements included in the asset, then the method may proceed to step 342.

In step 342, historical metadata is generated based on the at least one consolidated change list. In one or more embodiments of the invention, the backup agent generates historical metadata using the at least one consolidated change list. The backup agent may chronologically order the operations performed on each element in the at least one consolidated change list and may include the chronologically ordered operations of the elements of the asset in the historical metadata. The backup agent may also include information regarding each operation performed on the elements of the asset in the historical metadata. The backup agent may update the previously generated historical metadata generated using other change lists during the generation of the asset backup to include the generated historical metadata using the at least one consolidated change list. The historical metadata may be generated based on the at least one consolidated change list via other and/or additional methods without departing from the invention.

In step 344, asset backup data associated with the elements included in the change list is generated.

In one or more embodiments of the invention, the backup agent generates an asset backup using asset data associated with the asset based on the change list. The backup agent may obtain asset data associated with elements that are associated with intermediate operations that indicate the elements have been modified since the generation of a previously generated asset backup associated with the asset. The backup agent may include the obtained asset data in the asset backup as the asset backup data. The asset backup data associated with the elements included in the change list may be generated via other and/or additional methods without departing from the invention.

In step 346, asset backup metadata associated with the elements included in the change list is generated.

In one or more embodiments of the invention, the backup agent generates an asset backup metadata using asset metadata associated with the asset based on the change list. The backup agent may obtain asset metadata from the asset entry associated with the asset included in the file system metadata repository. The backup agent may include the obtained asset metadata in the asset backup as asset backup metadata. The backup agent may include the an asset backup identifier associated with the asset backup in the asset backup metadata. The backup agent may also include the asset backup identifier associated with the previously generated asset backup associated with asset in the asset backup repository. The backup agent may update the previously generated asset backup metadata generated using other change lists during the generation of the asset backup to include the generated asset backup metadata using the change list. The asset backup metadata associated with the elements included in the change list may be generated via other and/or additional methods without departing from the invention.

In step 348, the asset backup data is stored in a backup storage.

In one or more embodiments of the invention, the backup agent sends a message to a backup storage of the backup storages to store the asset backup data. The message may include the asset backup data and a request to store the asset backup metadata in persistent storage of the backup storage. The backup agent may obtain the storage location(s) of the asset backup data in the backup storage. The backup agent may update or the asset backup metadata to include the storage location(s) of the asset backup data. The asset backup data may be stored in the backup storage via other and/or additional methods without departing from the invention.

In step 350, a determination is made as to whether there are additional change lists.

In one or more embodiments of the invention, the backup agent determines whether any additional change lists are included in the change in the change information using the change list identifiers included in the change information. As discussed above the change information may include change list identifiers associated with each change list included in the change information. The backup agent may identify a change list identifier that was not previously identified during the generation of the asset backup. If the backup agent identifies an change list identifier that was not previously identified during the generation of the asset backup, then the backup agent may determine that an additional change list is included in the change information. If the backup agent does not identify a change list identifier that was not previously identified during the generation of the asset backup, then the backup agent may determine that no additional change lists are included in the change information. The determination as to whether any additional change lists are included in the change information may be made via other and/or additional methods without departing from the invention.

If it is determined that there is an additional change list included in the change information, then the method may proceed to step 330. If it is determined that there are no additional change lists included in the change information, then the method may proceed to step 352.

In step 352, the asset backup metadata and the historical metadata are stored in a backup storage.

In one or more embodiments of the invention, the backup agent sends a message to a backup storage of the backup storages to store the asset backup metadata and the historical metadata. The message may include the asset backup metadata, the historical metadata and a request to store the asset backup metadata and the historical metadata in persistent storage of the backup storage. The backup storage store the asset backup metadata obtained from the backup agent in persistent storage and may update the historical metadata associated with the asset to include the historical metadata obtained from the backup agent. The asset backup metadata and the historical metadata may be stored in the backup storage via other and/or additional methods without departing from the invention.

The method may end following step 352.

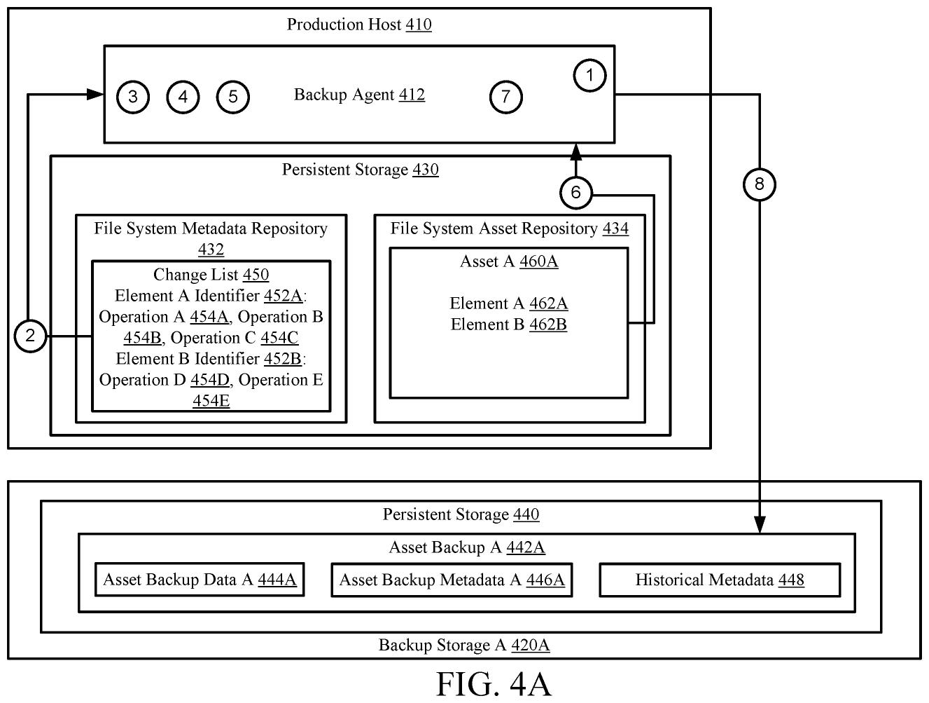

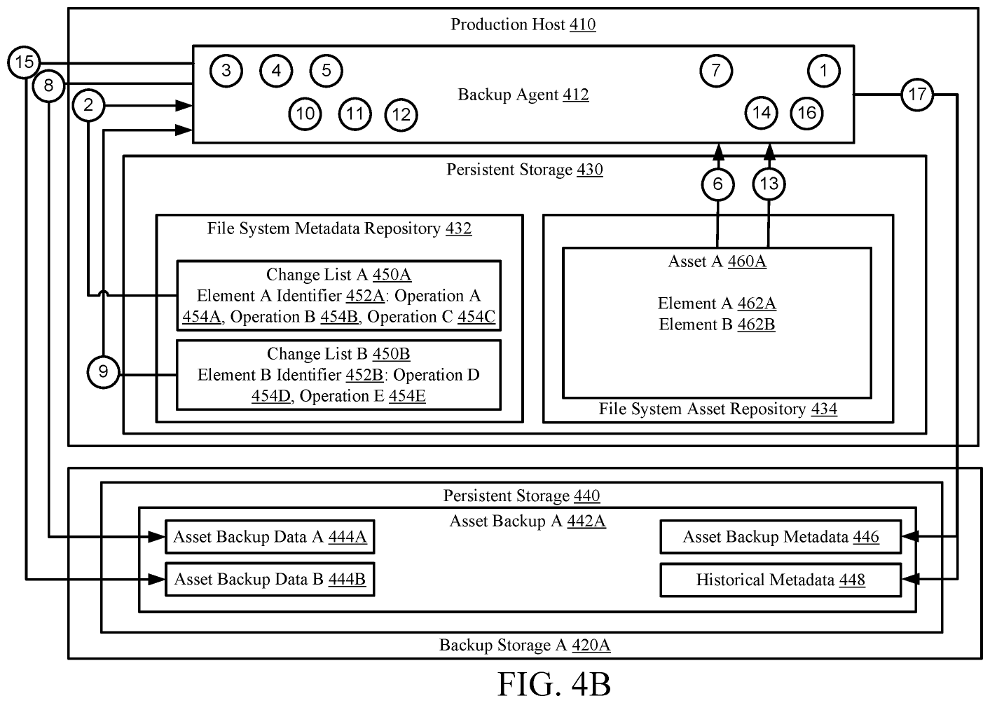

To further clarify embodiments of the invention, non-limiting examples are provided in FIGS. 4A and 4B. FIGS. 4A and 4B show diagrams of operations of an example system. FIGS. 4A and 4B may show a system similar to that illustrated in FIG. 1A. Actions performed by components of the system are illustrated by numbered, circular boxes interconnected with arrowed lines. For the sake of brevity, only a limited number of components illustrated in FIG. 1A are illustrated in FIGS. 4A and 4B.

### Examples

FIG. 4A shows a diagram of a first example in accordance with one or more embodiments of the invention. Turning to FIG. 4A, consider a scenario in which a backup agent (412) of a production host (410), at step 1, identifies a backup generation event associated with an application asset. The backup generation event specifies that the asset is asset A (460A). Asset A (460A) includes element A (462A) and element B (462B) and is stored in the file system asset repository (434) of the persistent storage (430) of the production host (410). In response to identifying the backup generation event, the backup agent (412), at step 2, obtains change information from the file system metadata repository (432). The change information includes the change list (450). The change list (450) includes the element A identifier (452A) associated with element A (462A) of asset A (460A). The change list (450) specifies that three operations were performed on element A (462A) since the previous asset backup of asset A (460A) was generated. The three operations include three modification operations, operation A (454A), operation B (454B), and operation C (454C). The change list (450) also includes the element B identifier (452B) associated with element B (462B) of asset A (460A). The change list (450) specifies that two operations were performed on element B (462B) since the previous asset backup of asset A (460A) was generated. The two operations include two modification operations, operation D (454D) and operation E (454E).

After obtaining the change information, at step 3, the backup agent (412) identifies a first element identifier included in the change list (450), element identifier A (452A). The backup agent (412) then generates a first consolidated change list by identifying intermediate backup operations as the operations specified by the change list (450) associated with the element A identifier (452A) (i.e., operation A (454A), operation B (454B), and operation C (454C)). At step 4, the backup agent then identifies a second element identifier included in the change list (450), element identifier B (452B). The backup agent (412) then generates a second consolidated change list by identifying intermediate backup operations as the operations specified by the change list (450) associated with the element B identifier (452B) (i.e., operation D (454D) and operation E (454E)).

After generating the first consolidated change list and the second consolidated change list, at step 5, the backup agent (412) determines that no other elements are included in Asset A (460A). As a result, at step 6, the backup agent (412) obtains asset data associated with element A (462A) and element B 462B) from the file system asset repository (434). At step 7, the backup agent (412) generates asset backup A (442) using the obtained asset data and obtained asset metadata (not shown) from the file system metadata repository (432) associated with asset A (460A). Asset backup A (442A) may include asset backup data A (444A), asset backup metadata A (446A) and historical metadata (448). The historical metadata (448) is generated using the first consolidated change list associated with element A (462A) and the second consolidated change list associated with element B (462B). At step 8, the backup agent (412) stores asset backup A (442A) in persistent storage (440) of backup storage A (420A). The historical metadata associated with asset A (460A) is updated to include the historical metadata (448) of asset backup A (442A).

FIG. 4B shows a diagram of a second example in accordance with one or more embodiments of the invention. Turning to FIG. 4B, consider a scenario in which a backup agent (412) of a production host (410), at step 1, identifies a backup generation event associated with an application asset. The backup generation event specifies that the asset is asset A (460A). Asset A (460A) includes element A (462A) and element B (462B) and is stored in the file system asset repository (434) of the persistent storage (430) of the production host (410). In response to identifying the backup generation event, the backup agent (412), at step 2, obtains change information from the file system metadata repository (432). The change information includes a first change list, change list A (450A). Change list A (450A) includes the element A identifier (452A) associated with element A (462A) of asset A (460A). Change list A (450A) specifies that three operations were performed on element A (462A) since the previous asset backup of asset A (460A) was generated. The three operations include three modification operations, operation A (454A), operation B (454B), and operation C (454C).

After obtaining the change list A (450A), at step 3, the backup agent (412) identifies a first element identifier included in change list A (450), element identifier A (452A). The backup agent (412) then, at step 4, generates a first consolidated change list by identifying intermediate backup operations as the operations specified by change list A (450A) associated with the element A identifier (452A) (i.e., operation A (454A), operation B (454B), and operation C (454C)). After that, at step 5, the backup agent (412) determines that no additional elements are specified in change list A (450A). Based on the determination, at step 6, the backup agent (412) obtains asset data associated with element A (462A) included in the file system asset repository of the persistent storage (430) of the production host (410). Then, at step 7, the backup agent (412) generates backup asset data A (444A), asset backup metadata associated with element A (462A) using asset metadata (not shown) obtained from the file system metadata repository (432), and historical metadata associated with element A (462A) using the first consolidated change list. At step 8, the backup agent (412) stores asset backup data A (444A) in persistent storage (440) of backup storage A (420A) and updates the asset backup metadata to include the storage location of asset backup data A (444A).

At step 9, the backup agent (412) determines a second change list is included in the change information, and the backup agent (412) obtains change list B (450B) from the file system metadata repository (432). Change list B (450B) includes the element B identifier (452B) associated with element B (462B) of asset A (460A). Change list B (450B) specifies that two operations were performed on element B (462B) since the previous asset backup of asset A (460A) was generated. The two operations include two modification operations, operation D (454D) and operation E (454E).

After obtaining change list B (450B), at step 10, the backup agent (412) identifies a first element identifier included in change list B (450B), element identifier B (452B). The backup agent (412) then, at step 11, generates a second consolidated change list by identifying intermediate backup operations as the operations specified by change list B (450B) associated with the element B identifier (452B) (i.e., operation D (454D) and operation E (454E)). After that, at step 12, the backup agent (412) determines that no additional elements are specified in change list B (450B). Based on the determination, at step 13, the backup agent (412) obtains asset data associated with element B (462B) included in the file system asset repository of the persistent storage (430) of the production host (410). Then, at step 14, the backup agent (412) generates backup asset data B (444B), asset backup metadata associated with element B (462B) using asset metadata (not shown) obtained from the file system metadata repository (432), and historical metadata associated with element B (462B) using the second consolidated change list. At step 15, the backup agent (412) stores asset backup data B (444B) in persistent storage (440) of backup storage A (420A) and updates the asset backup metadata to include the storage location of asset backup data B (444B). After asset backup data B (444B), at step 16, the backup agent (412) merges the asset backup metadata associated with element A (462A) with the asset backup metadata associated with element B (462B) to obtain asset backup metadata (446). The backup agent (412) also merges the historical metadata associated with element A (462A) with the historical metadata associated with element B (462B) to obtain historical metadata (448). At step 17, the backup agent (412) stores the asset backup metadata (446) and the historical metadata (448) in backup storage A (420A) to complete the generation of asset backup A (442A). The historical metadata associated with asset A (460A) is updated to include the historical metadata (448) of asset backup A (442A).

### End of Examples

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many different types of computing devices exist, and the aforementioned input and output device(s) may take other forms.

One or more embodiments of the invention may be implemented using instructions executed by one or more processors of the data management device. Further, such instructions may correspond to computer readable instructions that are stored on one or more non-transitory computer readable mediums.

One or more embodiments of the invention may improve the operation of one or more computing devices. More specifically, embodiments of the invention relate to generating asset backups of application asset with historical metadata. The asset backups may be generated using change information, the change information may include one or more change lists that specify operations performed on the assets since the generation of previously generated asset backups associated with the assets. Further, embodiments of the invention enable multiple change lists to be included in the change information. In such embodiments, a backup agent may be able to generate asset backup data associated with each list independently without waiting for and/or relying on the other change lists. The historical metadata and asset backup metadata in such scenarios may be associated with each portion of the asset backup data generated using each change list and may include the storage locations of the aforementioned portions of the asset backup data. Thus, the backup agent may efficiently generate asset backups using one or more change lists. Furthermore, the historical metadata may be used to generate one or more point in time restorations using a single asset backup, and may be used by users of the system to obtain a complete history of assets and elements associated with the assets. As a result, asset backups that include historical metadata may be more useful to users of the system.

Thus, embodiments of the invention may address the problem of inefficient use of computing resources to store and protect asset data. This problem arises due to the technological nature of the environment in which the asset data is stored.

The problems discussed above should be understood as being examples of problems solved by embodiments of the invention disclosed herein and the invention should not be limited to solving the same/similar problems. The disclosed invention is broadly applicable to address a range of problems beyond those discussed herein.

While the invention has been described with respect to a limited number of embodiments, those skilled in the art, having benefit of this disclosure, will appreciate that other embodiments can be devised which do not depart from the scope of the technology as disclosed herein. Accordingly, the scope of the invention should be limited only by the attached claims.

What is claimed is:

1. A method for generating backups of assets, the method comprising:
identifying, by a backup agent, a backup generation event associated with an asset;
in response to identifying the backup generation event:
obtaining change information associated with the asset, wherein the change information comprises at least one change list;
generating an asset backup using the at least one change list, wherein the asset backup comprises asset backup data, asset backup metadata, and historical metadata; and
storing the asset backup in a backup storage.

2. The method of claim 1, wherein generating the asset backup using the at least one change list comprises:
making a determination that a single change list is included in the change information;
in response to the determination:
identifying an element of the asset included in the single change list;
identifying intermediate operations associated with the element using the single change list;
identifying duplicate operations associated with the element using the single change list;
generating a consolidated change list associated with the element based on the intermediate operations and the duplicate operations;
generating the historical metadata based on the consolidated change list; and
generating the asset backup using asset data associated with the asset.

3. The method of claim 2, wherein the consolidated change list comprises chronologically ordered, non-duplicative operations performed on the element.

4. The method of claim 1, wherein generating the asset backup using the at least one change list comprises:
making a determination that a first change list and a second change list are included in the change information;
in response to the determination:
identifying first intermediate operations associated with a first element of the asset included in the first change list;
identifying first duplicate operations associated with the first element using the first change list;
storing first asset backup data for the first element in the backup storage, wherein the first asset backup data is generated using the first intermediate operations and the first duplicate operations;
identifying second intermediate operations associated with a second element of the asset included in the second change list;
identifying second duplicate operations associated with the second element using the second change list;
storing second asset backup data for the second element in the backup storage, wherein the second asset backup data is generated using the second intermediate operations and the second duplicate operations; and
storing the historical metadata in the backup storage, wherein the historical metadata comprises a first portion of the historical metadata associated with the first asset backup data and a second portion of the historical metadata associated with the second asset backup data.

5. The method of claim 1, wherein the change information specifies operations performed on elements of the asset since a previous asset backup associated with the asset was generated.

6. The method of claim 5, wherein the operations comprise at least one of:
moving the elements,
creating the elements,
deleting the elements, and
modifying the elements.

7. The method of claim 1, wherein the historical metadata specifies operations performed on elements of the asset and points-in-time associated with the performance of the operations.

8. A system for generating backups of assets, wherein the system comprises:
a backup storage comprising persistent storage; and
a backup agent, wherein the backup agent is configured to:
identify a backup generation event associated with an asset;
in response to identifying the backup generation event:
obtain change information associated with the asset, wherein the change information comprises at least one change list;
generate an asset backup using the at least one change list, wherein the asset backup comprises asset backup data, asset backup metadata, and historical metadata; and
store the asset backup in the backup storage.

9. The system of claim 8, wherein generating the asset backup using the at least one change list comprises:
making a determination that a single change list is included in the change information;
in response to the determination:
identifying an element of the asset included in the single change list;
identifying intermediate operations associated with the element using the single change list;
identifying duplicate operations associated with the element using the single change list;
generating a consolidated change list associated with the element based on the intermediate operations and the duplicate operations;
generating the historical metadata based on the consolidated change list; and
generating the asset backup using asset data associated with the asset.

10. The system of claim 9, wherein the consolidated change list comprises chronologically ordered, non-duplicative operations performed on the element.

11. The system of claim 8, wherein generating the asset backup using the at least one change list comprises:
making a determination that a first change list and a second change list are included in the change information;
in response to the determination:
identifying first intermediate operations associated with a first element of the asset included in the first change list;
identifying first duplicate operations associated with the first element using the first change list;
storing first asset backup data for the first element in the backup storage, wherein the first asset backup data is generated using the first intermediate operations and the first duplicate operations;
identifying second intermediate operations associated with a second element of the asset included in the second change list;
identifying second duplicate operations associated with the second element using the second change list;
storing second asset backup data for the second element in the backup storage, wherein the second asset backup data is generated using the second intermediate operations and the second duplicate operations; and
storing the historical metadata in the backup storage, wherein the historical metadata comprises a first portion of the historical metadata associated with the first asset backup data and a second portion of the historical metadata associated with the second asset backup data.

12. The system of claim 8, wherein the change information specifies operations performed on elements of the asset since a previous asset backup associated with the asset was generated.

13. The system of claim 12, wherein the operations comprise at least one of:
moving the elements,
creating the elements,
deleting the elements, and
modifying the elements.

14. The system of claim 8, wherein the historical metadata specifies operations performed on elements of the asset and points-in-time associated with the performance of the operations.

15. A non-transitory computer readable medium comprising computer readable program code, which when executed by a computer processor enables the computer processor to perform a method for generating backups of assets, the method comprises:
identifying, by a backup agent, a backup generation event associated with an asset;
in response to identifying the backup generation event:
obtaining change information associated with the asset, wherein the change information comprises at least one change list;
generating an asset backup using the at least one change list, wherein the asset backup comprises asset backup data, asset backup metadata, and historical metadata; and
storing the asset backup in a backup storage.

16. The non-transitory computer readable medium of claim 15, wherein generating the asset backup using the at least one change list comprises:
making a determination that a single change list is included in the change information;
in response to the determination:
identifying an element of the asset included in the single change list;
identifying intermediate operations associated with the element using the single change list;
identifying duplicate operations associated with the element using the single change list;
generating a consolidated change list associated with the element based on the intermediate operations and the duplicate operations;
generating the historical metadata based on the consolidated change list; and
generating the asset backup using asset data associated with the asset.

17. The non-transitory computer readable medium of claim 16, wherein the consolidated change list comprises chronologically ordered, non-duplicative operations performed on the element.

18. The non-transitory computer readable medium of claim 15, wherein generating the asset backup using the at least one change list comprises:
making a determination that a first change list and a second change list are included in the change information;
in response to the determination:
identifying first intermediate operations associated with a first element of the asset included in the first change list;
identifying first duplicate operations associated with the first element using the first change list;
storing first asset backup data for the first element in the backup storage, wherein the first asset backup data is generated using the first intermediate operations and the first duplicate operations;
identifying second intermediate operations associated with a second element of the asset included in the second change list;
identifying second duplicate operations associated with the second element using the second change list;
storing second asset backup data for the second element in the backup storage, wherein the second asset backup data is generated using the second intermediate operations and the second duplicate operations; and
storing the historical metadata in the backup storage, wherein the historical metadata comprises a first portion of the historical metadata associated with the first asset backup data and a second portion of the historical metadata associated with the second asset backup data.

19. The non-transitory computer readable medium of claim 15, wherein the change information specifies operations performed on elements of the asset since a previous asset backup associated with the asset was generated.

20. The non-transitory computer readable medium of claim 19, wherein the operations comprise at least one of:
moving the elements,
creating the elements,
deleting the elements, and
modifying the elements.
